(19) United States
(12) Patent Application Publication
(10) Pub. No.: US 2021/0085067 A1
(43) Pub. Date: Mar. 25, 2021

(54) Power Grill

(71) Applicant: Carter Evan Pasch, Rancho palos verdes, CA (US)

(72) Inventor: Carter Evan Pasch, Rancho palos verdes, CA (US)

(21) Appl. No.: 16/579,830

(22) Filed: Sep. 24, 2019

(51) Int. Cl. A46B 13/02; A47J 37/07

(52) U.S. Cl. CPC A46B 13/02; A47J 37/0786

(57) ABSTRACT

A drill-powered detachable BBQ grill brush with super cleaning power which can clean the BBQ grill effectively regardless of its temperature. The smart handle design makes it easy for the user to grab it firmly and reach out to the narrow or difficult places to remove the rust, debris, leftover food particles and dirt. It is also created specifically for cleaning food and rust off of grills/BBQ grates, which is typically done by hand with wired grill brush. The assembly can also be used to clean the stoves tops and other metal items restricting the use of brushes.

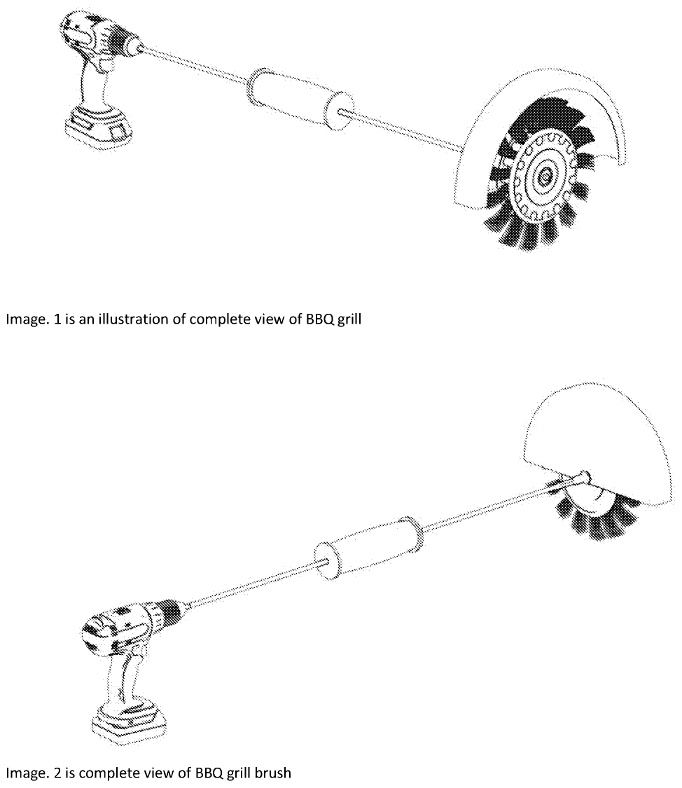

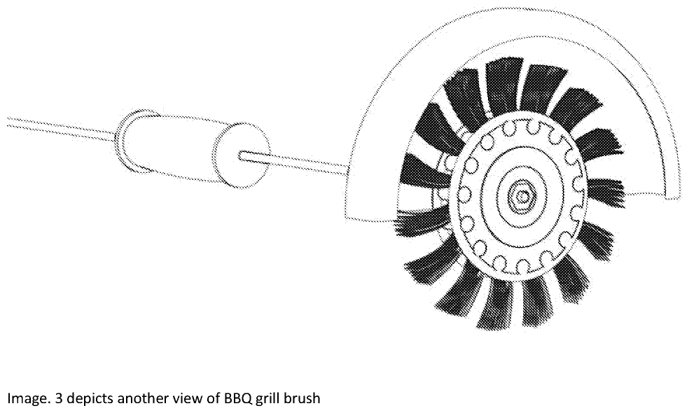

### BACKGROUND

### Field of the Invention

The present application is related to a detachable brush tool for maintaining a barbeque grill. More specifically, the present application is directed to a cleaning tool for cleaning and removing debris from a cooking grate in a barbeque grill wherein during use or not in use that can easily be attached to any drill.

### Description of the Related Art

Electronic appliances, such as ovens, toasters, electric ovens, and other food appliances, enjoy widespread popularity. The use of such equipment continues to be increasingly popular in view of rapid advancement in the electronics' industry.

Because of the substantial expense of items such as electric ovens or similar items, it is desirable to keep these electronic appliances in good working condition. However, there are many factors which contribute to the deterioration of such appliances.

For instance, during periods of use or nonuse, food particles and dust tend to collect on the surface, and often seep into the interior of the appliance.

A Multi-chambered convertible grilling device bearing US patent 2,006,001,1192A1 is issued to Citrynell Andrew. The patent discloses a grilling system comprising a multi-chambered grill base having a top, a bottom, and multiple chambers. The multiple chambers are adapted to receive multiple heatable substances. When applying a heat source to the bottom of the multi-chambered grill base, the multiple heatable substances produce multiple grilling flavors. The multiple grilling flavors mix together to produce a combination flavor that permeates either a fowl affixed to a removable vented tube having a plurality of vent holes or a grillable substance placed on a removable grilling structure having a plurality of holes. An optional lid to the grilling system provides for indoor or outdoor use on any heat source.

A Wipe for cleaning BBQ grills bearing Canadian patent 2,992,782A1 is issued to Proud Grill Co Ltd. The patent discloses a cleaning wipe and a method of using the same to clean surfaces such as BBQ grills. The wipe has a plurality of nodules extending outwardly from a base layer. The nodules are arranged in a pattern and present a number of faces that are oriented at different angles relative to each other. The base layer may be fabricated from a non-woven, spunlace, fibrous material and the nodules may be formed from different material such as PVC or rubber. Abrasive particles may be embedded in one or both of the base layer and nodules. The cleaning wipe may be grasped and brushed against the surface of the grill. The differently angled faces on the nodules provide for multi-directional scraping and removal of food, grease, grime and other materials stuck on the grill's surface.

A Rolling brush structure of grill greasy dirt cleaner bearing Canadian patent 2,0384,2857U is issued to Chinese inventor. The patent discloses a utility model related to a rolling brush structure of a grill greasy dirt cleaner. The rolling brush structure comprises a rolling brush, wherein the rolling brush is provided with a center through hole, the outer wall of the rolling brush is provided with a plurality of radial inserting holes which are arranged spirally as a whole, a pressing hole is formed in one end of the rolling brush, pressing sliding grooves are symmetrically formed in the inner side wall of the pressing hole, fixing countersinks are formed in the outer end faces of the pressing sliding grooves, and the other end of the rolling brush is symmetrically provided with fixing grooves. According to the rolling brush structure of the grill greasy dirt cleaner, bristles forming a spiral structure on the surface of the rolling brush, the phenomenon that in the rolling and scrubbing process, abreast bristles are caught in the position between a screen plate and a bar frame of a grill at the same time is avoided, scrubbing resistance is reduced, the cleaning effect is improved, and the service life of the rolling brush is prolonged.

A BBQ incorporating flip down latched vent and grill cleaning plate bearing US patent 1,008,5594B1 is issued to Jack J. Britvan. The patent discloses a barbeque stove having a firebox, a firebox hood forming smoke chamber incorporating at least one flip down vent providing means for vary the stove cooking temperature during a stove cooking session and a cleaning plate movable from a stove housing storage receptacle into the flip down vent overlaying the stove grill that will sufficiently concentrate the stove heat about the barbeque grill to incinerate food residue thereon with the firebox and/or hood providing flanges for supporting the grill cleaning sheet.

A BBQ easy cleaning basket bearing US patent 2,002,009,6168A1 is issued to Richard Weinmann, Milan Korman. The patent discloses a BBQ Easy Cleaning Basket which is made from expanded metal, metal mesh, etc. It has 2 parts; top and bottom held together by metal connecting screws, with a handle on each side. The basket is filled with various stones and/or briquettes and is to be placed in the BBQ body. The purpose is to keep all stones and/or briquettes together, therefore allowing even heat distribution while cooking. After cooking the stones and/or briquettes are covered by food residue and grease drippings. This is our main idea; that the stones and/or briquettes are rotated all at once and the residue is burned from the bottom, because the Easy Cleaning BBQ Basket is placed over the burner in the BBQ as shown.

A Cleaning device of grill greasy dirt cleaner bearing Canadian patent 2,038,42856U is issued to Chinese inventor. The patent discloses a utility model relates to a cleaning device of a grill greasy dirt cleaner. The cleaning device comprises a rolling brush and a driving motor, wherein a rolling brush shaft and a pressing block are oppositely arranged in a center through hole of the rolling brush, the pressing block is provided with an extrusion hole used for the end of the rolling brush shaft to insert, one end of the rolling brush shaft is connected with a motor shaft, the other end of the rolling brush shaft is connected with the rolling brush through a limiting shaft, a plurality of inserting holes are spirally formed in the outer wall of the rolling brush, bristles are inserted in the inserting holes, one end of the rolling brush is provided with a pressing hole used for installing the pressing block and a limiting screw, the two sides of one end of the rolling brush shaft are symmetrically connected with guide plates, the guide plates are installed in fixing grooves in one end of the rolling brush, a through separating groove is formed in the other end of the rolling brush shaft, extrusion plates on the two sides of the separating groove are respectively provided with a wedged round end, the wedged round ends are inserted in the pressing hole, and the ends of the wedged round ends are placed in the pressing hole of the pressing block. When the cleaning device of the grill greasy dirt cleaner works, washing resistance is small, the cleaning effect is good, the rolling brush is easy and convenient to replace, and operation efficiency is high.

A BBQ grill scraper and cleaner bearing U.S. Pat. No. 9,943,885B1 is issued to Charboss LLC. The patent discloses a barbeque grill scraper that uses a scraping edge with a tooth formed of a wearable material to remove char and debris from the grill grates. The tooth fits between adjoining grill grates to guide the scraping edge and create a plurality of indents in the scraping edge that match the top profile of the grill grates. The grill grates are thus thoroughly cleaned without the health risks associated with wire brush cleaners. Another embodiment further utilizes a protruding cleaning tool to access and clean the lower sides and bottom of the grill grates.

There are multiple solutions that have been presented in prior art. However, these solutions are limited and restricted to their conventional systems. The current invention is focused on presenting an assembly which is directed toward easily cleaning the grill assembly with a brush that's detachable and easily fits into any cordless electric drill. The proposed assembly can clean the BBQ grill whether it's in use or not.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of a BBQ Grill cleaner brush which can clean the grill effectively regardless of its temperature.

It is also the primary objective of the invention to provide a smart cleaning assembly which can quickly clean rust off from grill using the power from a drill.

It is another objective of the invention to provide a main assembly made of easy to grip handle which makes it easy for the user to hold and clean the BBQ grill.

It is also the object of the invention to provide an assembly which is detachable and can easily be simply attached to a drill and ready to use.

It is also the object of the invention to provide a BBQ grill cleaning assembly which is time efficient and quickly removes the dirt, grease and left-over food particles with less user input.

It is further the objective of the invention to provide an advance assembly that is simple and convenient to use.

It is further the object of invention to provide an assembly which is susceptible of a low cost of manufacture with regard to both materials and labor, and which accordingly is then susceptible of low prices of sale to the consuming public, thereby making such cleaning assembly economically available to the buying public.

It is a further aspect of the present invention to provide a new and improved BBQ Grill assembly which is of a durable and reliable construction and can sustain its effectiveness after multiple and consistent use.

It is also the objective of the invention to provide an efficient cleaning system which is highly portable and cost effective.

It is furthermore the objective of the invention to provide scrubber which won't scratch, or damage surface of BBQ grill.

Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to an advanced form of grill brush which can effectively clean the assembly regardless of the temperature.

Regardless of grill design or location, one common result is the formation of charred debris on a grate surface of the grill. This charred debris is formed from the foods being cooked on the grate surface including meat, fish, vegetables and the like. The presence of this charred debris on the grate surface can create an unsatisfactory eating experience by having a detrimental impact on the taste and appearance of food being cooked. Generally, users are encouraged to remove the charred debris and a variety of cleaning tools are commercially available including a wide variety of brush and scraper tools.

Unfortunately, commercially-available cleaning tools suffer from a number of issues. Brushes often become clogged with debris such that a user is cleaning a dirty grilling grate with a dirty brush. Scrapers generally have a hard scraping surface that can clean an upper surface of the grill grate but do not conform well with rounded surfaces that are frequently present on grill grates such that the charred debris often remains present on the sides and bottoms of the grill grate. As there are a variety of issues with commercially available grill cleaning tools, it would be advantageous to have a new grill cleaning tool that is well equipped to deal with charred debris of the type found on almost every barbeque grill grate.

The current invention as per its preferred embodiment presents a grill cleaning tool which proposes to clean the grill regardless of its temperature. The assembly strong mechanism allows it to reach to every nook and corner of the assembly and performs the cleaning assembly effectively. The cordless drill powered assembly simply attaches and is ready to go.

The assembly as per its further embodiment quickly remove the dirt, left over and debris from the BBQ Grill assembly. The assembly also helps in removing the rust and quickly cleans the interior. The easy to grip handle allows the user to reach the interior and saves the user effort and time.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

Image. 1 is an illustration of complete view of BBQ grill brush as per exemplary embodiments of the invention.

Image. 2 is complete view of BBQ grill brush with the exemplary embodiments of the present invention.

Image. 3 depicts another view of BBQ grill brush as per preferred embodiment of the invention

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

I: A BBQ Grill cleaning tool, comprising:
a BBQ grill cleaner brush having a grasping handle at its mid-section;
a brush with wires bristles to achieve the cleaning;
a rod to extend or adjust the length of cleaning tool;
a rod which holds the brush and attaches to a drill
a fender to prevent mess;

II: A BBQ grill cleaning assembly designed for cleaning food and rust off of grills/BBQ grates, which is typically done by hand or with brushes. The assembly can also be used to clean the stoves tops and other metal items.
